(19) United States
(12) Patent Application Publication
(10) Pub. No.: US 2017/0043439 A1
(43) Pub. Date: Feb. 16, 2017

(54) VIBRATION SUPPRESSION METHOD FOR SUPPRESSING VIBRATION OF OBJECT TO BE PROCESSED, AND MACHINE PROCESSING SYSTEM

(71) Applicant: FANUC CORPORATION, Yamanashi (JP)

(72) Inventor: Masahiro NAITOU, Yamanashi (JP)

(21) Appl. No.: 15/231,785

(22) Filed: Aug. 9, 2016

(30) Foreign Application Priority Data
Aug. 10, 2015 (JP) 2015-158309

(51) Int. Cl. B23Q 3/06; B23Q 11/00

(52) U.S. Cl. CPC B23Q 3/069; B23Q 11/0032

(57) ABSTRACT

A vibration suppression method and a machine processing system for properly suppressing vibration of a workpiece during processing, by which it is not necessary that a fixing jig for a workpiece be provided with a special device. A robot has a movable section and a gripping section such as a hand attached to a front end of the movable section. The gripping section is configured to grip a portion of the workpiece, which is different from a part of the workpiece held by the fixing jig, during machining of the workpiece by a machine tool. By holding the workpiece by using the robot during the machining of the workpiece, the workpiece can be prevented from being deformed by a machining reaction force, whereby vibration generated during the machining can be limited.

### BACKGROUND OF THE INVENTION

1. Field of the Invention

The present invention relates to a method for suppressing vibration of an object to be processed, during machine processing of the object, and relates to a machine processing system that can suppress the vibration of the object.

2. Description of the Related Art

In machine processing in a machine tool, it is desired to increase a rotational frequency and/or a feed rate of a cutting tool in order to reduce a processing time. In this regard, if such a processing condition is inappropriate, vibration of a machine element of the machine tool or an object to be processed may occur, which deteriorates the quality of the machine processing of the object.

As a method for suppressing vibration during the machine processing, a method of setting a less severe processing condition, for example, lowering a rotational frequency and/or a feed rate of a spindle of a machine tool, is common. Further, in many cases, a component for increasing stiffness of an object to be processed is arranged on a jig for fixing the object. As a relevant prior art document, JP 2009-517228 A discloses a method in which an additional mass is attached to at least one of a machine element and a workpiece, so that a natural frequency of the machine element or the workpiece is changed, whereby vibration is reduced.

Generally, when the processing condition is relaxed, the processing time is extended. Further, when the component for increasing the stiffness of the object is added to the jig for fixing the object, the structure of the processing jig is complicated, whereby the cutting tool easily interferes with the processing jig. With regard to attaching of the additional mass as described in JP 2009-517228 A, the deformation of the mechanical element or the workpiece due to the additional mass may affect processing accuracy of the workpiece. Further, it is necessary to prepare another component for fixing the additional mass to the mechanical element or the workpiece, which may increase cost.

### SUMMARY OF THE INVENTION

An object of the present invention is to provide a vibration suppression method and a machine processing system for properly suppressing vibration of a workpiece during processing, by which it is not necessary that a fixing jig for a workpiece be provided with a special device.

One aspect of the present invention provides a method for suppressing vibration of an object to be processed, the vibration being generated when the object is held by a fixing jig and is machined by a machine tool, the method comprising: holding a portion of the object by using a robot, during machining of the object, wherein the portion of the object held by the robot is different from a part of the object held by the fixing jig.

In a preferred embodiment, the robot has a gripping section and the robot holds the object by gripping the portion of the object by using the gripping section.

In a preferred embodiment, the robot has an abutting section and the robot holds the object by abutting the abutting section against the portion of the object.

In a preferred embodiment, the robot has a fitting section and the robot holds the object by fitting the fitting section with a fitted portion of the object.

Another aspect of the present invention provides a machine processing system comprising: a machine tool which machines an object held by a fixing jig; and a robot which holds a portion of the object, during machining of the object, wherein the portion of the object held by the robot is different from a part of the object held by the fixing jig.

In a preferred embodiment, the robot has a gripping section for holding the object by gripping the portion of the object.

In a preferred embodiment, the robot has an abutting section for holding the object by being abutted against the portion of the object.

In a preferred embodiment, the robot has a fitting section for holding the object by being fitted with a fitted portion of the object.

In a preferred embodiment, the robot is configured to carry out a cooperative operation with the machine tool, as well as the holding of the object

### BRIEF DESCRIPTION OF THE DRAWINGS

The above and other objects, features and advantages of the present invention will be made more apparent by the following description of the preferred embodiments thereof with reference to the accompanying drawings wherein:

FIG. 1 is a schematic view showing a machine processing system according to a first embodiment of the present invention;

FIG. 2 is a schematic view showing a machine processing system according to a second embodiment of the present invention; and

FIG. 3 is a schematic view showing a machine processing system according to a third embodiment of the present invention.

### DETAILED DESCRIPTION

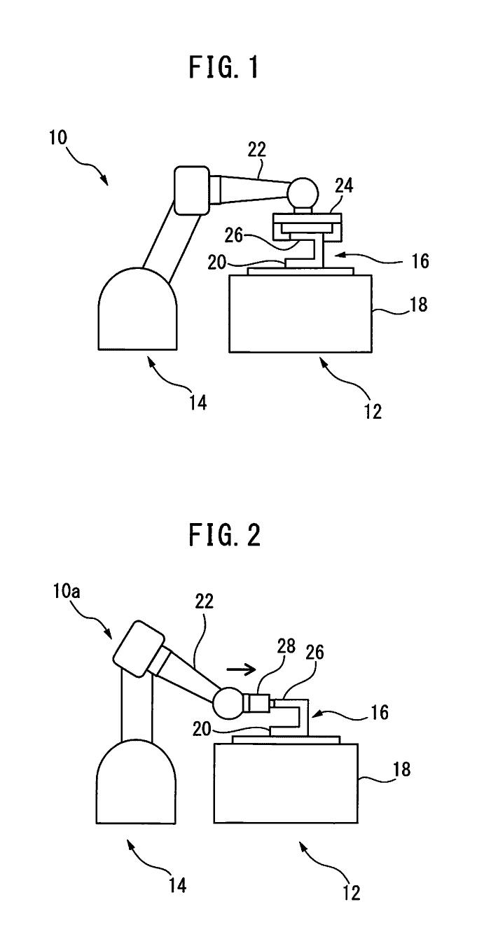

FIG. 1 is a schematic view showing a machine processing system 10 according to a first embodiment of the present invention. Machine processing system 10 has a machine tool 12 such as an NC machine tool, and a robot 14. Regarding machine tool 12, only a fixing jig 18 for fixing an object (workpiece 16) to be machined by machine tool 12 is shown. In the illustrated embodiment, workpiece 16 is a component having a generally H shape when viewed from a lateral side, and a lower part of workpiece 16 is held by fixing jig 18 when workpiece 16 is processed by a tool of machine tool 12.

For example, robot 14 is a multi-joint robot having six axes, and has a movable section (robot arm) 22 and a gripping section (gripping component) 24 such as a hand attached to a front end of the movable section. Gripping section 24 is configured to grip a portion (in this case, an upper part 26) of workpiece 16, which is different from the part (in this case, lower part 20) of workpiece 16 held by fixing jig 18, during machining of workpiece 16 by machine tool 12. As such, by holding workpiece 16 by using robot 14, during the machining of workpiece 16, workpiece 16 can be prevented from being deformed by a machining reaction force, whereby vibration generated during the machining can be limited.

FIG. 2 is a schematic view showing a machine processing system 10a according to a second embodiment of the present invention. The second embodiment is different from the first embodiment in that gripping section 24 of robot 14 is replaced with an abutting section 28, and the other components may be the same as the first embodiment. Therefore, in the second embodiment, only abutting section 28 and relevant components will be explained. Further, to the components of the second embodiment corresponding to the components of the first embodiment, the same reference numerals are added, and detailed explanations thereof will be omitted.

For example, robot 14 is a multi-joint robot having six axes, and has a movable section (robot arm) 22 and an abutting section (abutting component) 28 attached to a front end of the movable section. Abutting section 28 is configured to contact a portion (in this case, upper part 26) of workpiece 16 in a predetermined direction (in this case, in the right direction) so as to hold the workpiece, which is different from the part (in this case, lower part 20) of workpiece 16 held by fixing jig 18, during machining of workpiece 16 by machine tool 12.

Fixing jig 18 is configured to hold workpiece 16 so that workpiece 16 is not moved at least in the abutting direction of abutting section 28 (in this case, in the right direction). As such, by holding workpiece 16 by using robot 14, during the machining of workpiece 16, workpiece 16 can be prevented from being deformed by a machining reaction force, whereby vibration generated during the machining can be limited, similarly to the first embodiment.

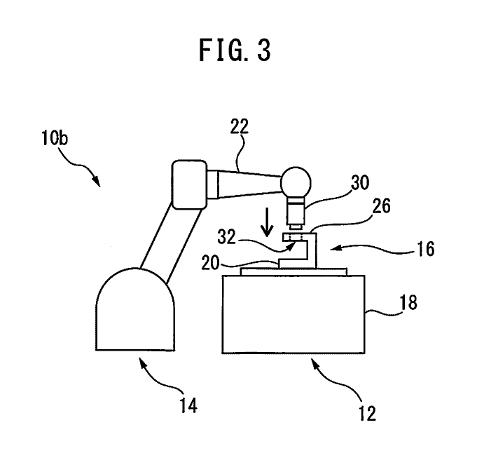

FIG. 3 is a schematic view showing a machine processing system 10b according to a third embodiment of the present invention. The third embodiment is different from the first embodiment in that gripping section 24 of robot 14 is replaced with a fitting section 30, and the other components may be the same as the first embodiment. Therefore, in the third embodiment, only fitting section 30 and relevant components will be explained. Further, to the components of the third embodiment corresponding to the components of the first embodiment, the same reference numerals are added, and detailed explanations thereof will be omitted.

For example, robot 14 is a multi-joint robot having six axes, and has a movable section (robot arm) 22 and a fitting section (fitting component) 30 attached to a front end of the movable section. Fitting section 30 is configured to fit with a portion (in this case, upper part 26) of workpiece 16 so as to hold the workpiece, which is different from the part (in this case, lower part 20) of workpiece 16 held by fixing jig 18, during machining of workpiece 16 by machine tool 12.

Concretely, a fitted part (or a fitting hole) 32 is previously formed on upper part 26 of workpiece 16, and fitting section 30 has a feature (or a protrusion) configured to be engaged with fitting hole 32 of workpiece 16. Otherwise, a protrusion may be previously formed as the fitted part on upper part 26 of workpiece 16, and fitting section 30 may have a fitting hole configured to be engaged with the protrusion. As such, by holding workpiece 16 by using robot 14, during the machining of workpiece 16, workpiece 16 can be prevented from being deformed by a machining reaction force, whereby vibration generated during the machining can be limited, similarly to the first embodiment.

In the above embodiment, although robot 14 may be used to merely hold workpiece 16 during the machining thereof, robot 14 may be configured to carry out an operation (e.g., a cooperative operation with machine tool 12) other than the holding of the workpiece. For example, robot 14 may be configured to supply a workpiece to be processed by machine tool 12 and discharge the workpiece after being processed by machine tool 12. As such, when the robot prepared for the purpose other than the holding of the workpiece is also used to hold the workpiece during the machining thereof, the more effective machine processing system can be constituted at low cost.

In any of the above embodiments, by contacting the movable section of the robot with the portion of the workpiece other than the part of the workpiece held by the fixing jig of the machine tool, so as to hold the workpiece, the workpiece can be prevented from being deformed by the machining reaction force during the machining of the workpiece, and the vibration of the workpiece generated during the machining can be limited.

According to the present invention, it is not necessary to arrange a special component or device on a fixing jig or a workpiece to be processed, in order to suppress vibration of the workpiece. Since a robot is used to hold the workpiece, even when the portion of the workpiece to be held is different depending on the shape or type of the workpiece, the portion of the workpiece can be appropriately held. Further, the robot can be flexibly used, for example, the robot can hold the workpiece only when the workpiece is processed, and the robot can move away from the machine tool when the workpiece is not processed.

While the invention has been described with reference to specific embodiments chosen for the purpose of illustration, it should be apparent that numerous modifications could be made thereto, by a person skilled in the art, without departing from the basic concept and scope of the invention.

1. A method for suppressing vibration of an object to be processed, the vibration being generated when the object is held by a fixing jig and is machined by a machine tool, the method comprising:
holding a portion of the object by using a robot, during machining of the object, wherein the portion of the object held by the robot is different from a part of the object held by the fixing jig.

2. The method as set forth in claim 1, wherein the robot has a gripping section and the robot holds the object by gripping the portion of the object by using the gripping section.

3. The method as set forth in claim 1, wherein the robot has an abutting section and the robot holds the object by abutting the abutting section against the portion of the object.

4. The method as set forth in claim 1, wherein the robot has a fitting section and the robot holds the object by fitting the fitting section with a fitted portion of the object.

5. A machine processing system comprising:
a machine tool which machines an object held by a fixing jig; and
a robot which holds a portion of the object, during machining of the object, wherein the portion of the object held by the robot is different from a part of the object held by the fixing jig.

6. The machine processing system as set forth in claim 5, wherein the robot has a gripping section for holding the object by gripping the portion of the object.

7. The machine processing system as set forth in claim 5, wherein the robot has an abutting section for holding the object by being abutted against the portion of the object.

8. The machine processing system as set forth in claim 5, wherein the robot has a fitting section for holding the object by being fitted with a fitted portion of the object.

9. The machine processing system as set forth in claim 5, wherein the robot is configured to carry out a cooperative operation with the machine tool, as well as the holding of the object.
